(19) United States
(12) Patent Application Publication
(10) Pub. No.: US 2015/0103719 A1
(43) Pub. Date: Apr. 16, 2015

(54) METHOD, APPARATUS, AND SYSTEM FOR DISABLING STANDARD NETWORK

(71) Applicant: Huawei Technologies Co., Ltd., Shenzhen (CN)

(72) Inventors: Yongmei ZENG, Shanghai (CN); Ziyan LIU, Nanjing (CN); Haitao XIA, Beijing (CN); Jiang ZHU, Shanghai (CN)

(21) Appl. No.: 14/572,469

(22) Filed: Dec. 16, 2014

Related U.S. Application Data
(63) Continuation of application No. PCT/CN2012/077943, filed on Jun. 29, 2012.

(51) Int. Cl. H04W 52/02; H04W 88/06

(52) U.S. Cl. CPC H04W 52/0206; H04W 88/06
USPC 370/311

(57) ABSTRACT

The present invention relates to a method, an apparatus, and a system for disabling a standard network. The method includes: acquiring processing capability information of all standard networks in a multi-standard network; judging, according to the processing capability information of all of the standard networks, whether to disable a first standard network; when it is necessary to disable the first standard network, sending disabling information to the first standard network which needs to be disabled; sending information of subscribing to a first energy conservation event to a second standard network; and when information of triggering the first energy conservation event returned by the second standard network is received, sending enabling information to the first standard network. Therefore, in the method, disablement and enablement of a base station or cell in a multi-standard network is uniformly coordinated and managed by a network management system. Moreover, the method adapts to variations of services in the multi-standard network, and in particular, to a burst service.

### CROSS-REFERENCE TO RELATED APPLICATIONS

This application is a continuation of International Patent Application No. PCT/CN2012/077943, filed on Jun. 29, 2012, which is hereby incorporated by reference in its entirety.

### FIELD OF THE INVENTION

The present invention relates to the field of communications, and in particular, to a method, an apparatus, and a system for disabling a standard network.

### BACKGROUND OF THE INVENTION

In radio communications systems, energy conservation and emission reduction has an important status. With the coexistence of multiple standard networks, for example, the global system for mobile communications (Global System for Mobile Communications, GSM), the universal mobile telecommunications system (Universal Mobile Telecommunications System, UMTS), and the long term evolution (Long Term Evolution, LTE), the energy conservation management of a multi-standard network is increasingly emphasized.

A method for performing energy conservation management on a system of a single standard in the prior art refers to performing statistic analysis on network performance measurement data by using a network management system so as to regularly disable and enable a base station or cell/cell of the single standard after an idle time segment of network traffic is determined, or, performing periodic judgment by using the network management system according to the statistics of the network performance measurement data, thereby making the base station or cell/cell of the single standard enter an energy conservation state when a load is low and exit the energy conservation state when the load increases.

However, a period of the network performance measurement data is generally 15 minutes or 30 minutes at present. Neither regularly disabling and enabling the base station or cell of the single standard nor periodically doing so can adapt to variations of network services so as to enable the single standard in time, and neither regularly doing so nor periodically doing so can further adapt to a burst network service.

Meanwhile, with respect to the problem of energy conservation of multiple standards, standardization organizations, for example, the 3rd generation partnership project (3rd Generation Partnership Project, 3GPP) standardization organization and the Radio Access Network (Radio Access Network, RAN) standardization organization, have already begun to study solutions for solving the problem. The current method is that statistic analysis is performed on the network performance measurement data by using a network management system, and thereby a network element of the standard decides to disable or enable a base station or cell after an idle time segment of network traffic is determined.

However, when the network element of the standard decides to disable or enable the base station or cell/cell according to a condition of the network element of the standard and a condition of the network element of another standard, information may be exchanged between network elements. Meanwhile, in a condition of multiple standards, energy conservation processing of base stations or cells of each standard is independent of each other, thereby lacking uniform coordination and management.

### SUMMARY OF THE INVENTION

Embodiments of the present invention provide a method, an apparatus, and a system for disabling a standard network, which solve the problem of lacking uniform coordination and management and meanwhile being incapable of adapting to a burst network service in the prior art, implement that a network management system uniformly coordinates and manages disablement of a base station or cell where a multi-standard network is located, adapt to variations of network services, and in particular, adapt to a burst network service.

In one aspect, an embodiment of the present invention provides a method for disabling a standard network, the method including:

acquiring processing capability information of all standard networks in a multi-standard network;

judging, according to the processing capability information of all of the standard networks, whether to disable a first standard network;

when it is necessary to disable the first standard network, sending disabling information to the first standard network, so that the first standard network disables the first standard network according to the disabling information;

sending information of subscribing to a first energy conservation event to a second standard network, so that the second standard network judges, according to a processing capability of the second standard network, whether the processing capability is sufficient enough to bear total traffic of the second standard network; and

when information of triggering the first energy conservation event returned by the second standard network is received, sending enabling information to the first standard network, so that the first standard network enables the first standard network according to the enabling information.

In a second aspect, an embodiment of the present invention provides a method for disabling a standard network, the method including:

sending processing capability information of a local standard network to a network management system, so that the network management system judges, according to the processing capability information, whether the local standard network needs to be disabled;

receiving information sent by the network management system;

if the received information sent by the network management system is disabling information or enabling information, disabling or enabling, by the local standard network, the local standard network according to the disabling information or the enabling information;

if the received information sent by the network management system is information of subscribing to a first energy conservation event, judging, according to a processing capability of the local standard network, whether the processing capability is sufficient enough to bear total traffic of the local standard network; and

when the local standard network is incapable of bearing the total traffic accessed to the local standard network, triggering the first energy conservation event and sending information of triggering the first energy conservation event to the network management system, so that the network management system enables a disabled standard network.

In a third aspect, an embodiment of the present invention provides an apparatus for disabling a standard network, the apparatus including:

a first acquisition unit, configured to acquire processing capability information of all standard networks in a multi-standard network;

a first judgment unit, configured to judge, according to the processing capability information of all of the standard networks, whether to disable a first standard network;

a first disabling unit, configured to: when it is necessary to disable the first standard network, send disabling information to the first standard network, so that the first standard network disables the first standard network according to the disabling information;

a first sending unit, configured to send information of subscribing to a first energy conservation event to a second standard network, so that a standard network which is not disabled judges, according to a processing capability thereof, whether the processing capability is sufficient enough to bear total traffic accessed to the standard network which is not disabled; and a first receiving unit, configured to: when information of triggering the first energy conservation event returned by the second standard network is received, send enabling information to the first standard network, so that the first standard network enables the first standard network according to the enabling information.

In a fourth aspect, an embodiment of the present invention provides an apparatus for disabling a standard network, the apparatus including:

a sending unit, configured to send processing capability information of a local standard network to a network management system, so that the network management system judges, according to the processing capability information, whether the local standard network needs to be disabled;

a receiving unit, configured to receive information sent by the network management system;

a first executing unit, configured in that if the received information sent by the network management system is disabling information or enabling information, the local standard network disables or enables the local standard network according to the disabling information or the enabling information; and

a second executing unit, configured to: if the received information sent by the network management system is information of subscribing to a first energy conservation event, judge, according to a processing capability of the local standard network, whether the processing capability is sufficient enough to bear total traffic accessed to the local standard network, and when the local standard network is incapable of bearing the total traffic accessed to the local standard network, trigger the first energy conservation event and send information of triggering the first energy conservation event to the network management system, so that the network management system enables a disabled standard network.

In a fifth aspect, an embodiment of the present invention provides a system for disabling a standard network, the system including an apparatus for disabling a standard network according to any one of claims 11 to 16 and multiple apparatuses for disabling a standard network according to any one of claims 17 to 20.

By applying the foregoing solutions, the embodiments of the present invention implement that a network management system uniformly coordinates and manages the disablement of a base station or cell where a multi-standard network is located, adapt to variations of services of the multi-standard network, and in particular, adapt to a burst service of the multi-standard network.

### BRIEF DESCRIPTION OF THE DRAWINGS

FIG. 1 is a schematic diagram of an application scenario of a method for disabling a standard network according to Embodiment 1 of the present invention;

FIG. 2 is a flowchart of a method for disabling a standard network according to Embodiment 2 of the present invention;

FIG. 3 is a flowchart of a method for disabling a standard network according to Embodiment 3 of the present invention;

FIG. 4 is a flowchart of a method for disabling a standard network according to Embodiment 4 of the present invention;

FIG. 5 is a flowchart of a method for disabling a standard network according to Embodiment 5 of the present invention;

FIG. 6 is a flowchart of a method for disabling a standard network according to Embodiment 6 of the present invention;

FIG. 7 is a diagram of information exchange of a method for disabling a standard network according to Embodiment 7 of the present invention;

FIG. 8 is a diagram of information exchange of a method for disabling a standard network according to Embodiment 8 of the present invention;

FIG. 9 is a schematic diagram of an apparatus for disabling a standard network according to Embodiment 9 of the present invention; and

FIG. 10 is a schematic diagram of an apparatus for disabling a standard network according to Embodiment 10 of the present invention.

### DETAILED DESCRIPTION OF THE EMBODIMENTS

To make the objectives, technical solutions, and advantages of the present invention more comprehensible, the following clearly and describes the technical solutions according to the embodiments of the present invention with reference to the accompanying drawings in the embodiments of the present invention. Apparently, the embodiments in the following description are merely a part rather than all of the embodiments of the present invention. All other embodiments obtained by persons skilled in the art based on the embodiments of the present invention without creative efforts shall fall within the protection scope of the present invention.

An embodiment of the present invention provides a method for disabling a standard network. The method is applied to a network management system and multiple base stations or cells which are uniformly managed by the network management system and belong to a multi-standard network. The network management system determines, according to acquired processing capability information of each standard network in the multi-standard network, or in combination with network element determination information obtained in a manner of subscribing to a second energy conservation event, whether the standard network needs to be disabled, and when it is determined that the standard network needs to be disabled, sends disabling information to the base stations or cells in the standard network. Meanwhile, the network management system identifies, in a manner of subscribing to a first energy conservation event, whether a standard network which is not disabled is sufficient enough to bear traffic of a base station or cell in a disabled standard network. If the standard network which is not disabled is incapable of bearing the traffic of the disabled base station or cell, the standard network that is not disabled notifies the network management system and makes a request for enabling the disabled standard network. The network management system selects a proper base station or cell and a cell in a disabled network to send enabling information and sends the enabling information to the base station or cell in the disabled standard network. In the multi-standard network, each standard network sends processing capability information of a local standard network, or the processing capability information of the local standard network and network element determination information, to the network management system, so that the network management system judges whether the standard network needs to be disabled, receives disabling information sent by the network management system, and disables the base station or cell in the local standard network according to the disabling information. Meanwhile, when a standard network which is not disabled is incapable of bearing the traffic of the base station or cell in the disabled standard network or when a user terminal of high quality of service accesses, the standard network which is not disabled notifies the network management system and requests the network management system to enable the base station or cell in the disabled standard network.

Therefore, the method for disabling a standard network provided in the embodiment of the present invention implements that the network management system uniformly coordinates and manages the disablement of the base stations or cells where the multi-standard network is located, adapts to variations of services in the multi-standard network, and in particular, adapts to a burst service in the multi-standard network.

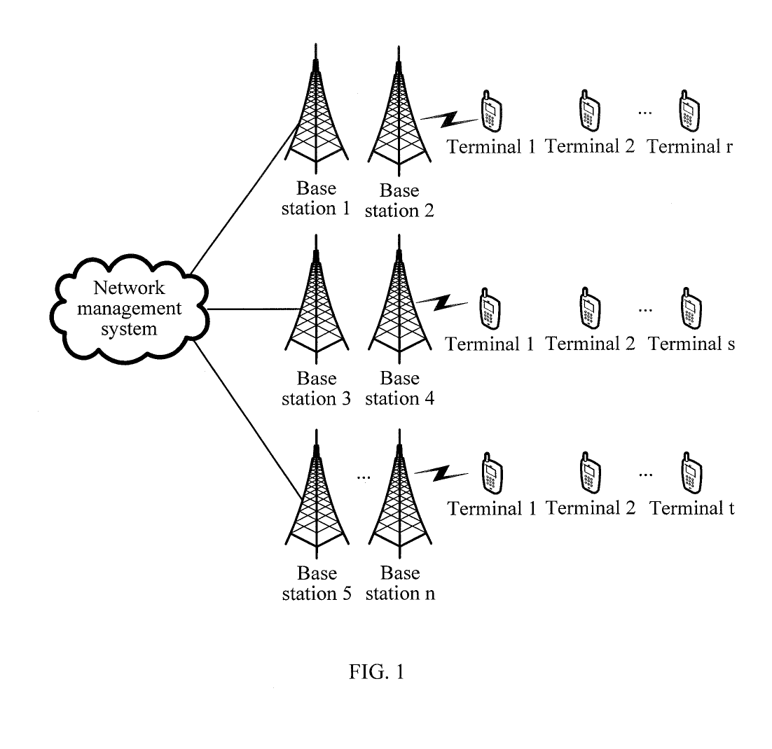

FIG. 1 is a schematic diagram of an application scenario of a method for disabling a standard network provided in Embodiment 1 of the present invention. As shown in FIG. 1, the embodiment of the present invention specifically includes: a network management system, a base station or cell 1, a base station or cell 2, . . . , and a base station or cell n. The base station or cell 1 covers a terminal 1, a terminal 2, . . . , and a terminal r. The base station or cell 2 covers a terminal 1, a terminal 2, . . . , and a terminal s. The base station or cell n covers a terminal 1, a terminal 2, . . . , and a terminal t. The number n of the base stations or cells and the numbers r, s, and t of the terminals are determined according to actual conditions. In addition, the terminal may be a fixed terminal device or a mobile terminal device.

The base station or cell 1, the base station or cell 2, . . . , and the base station or cell n are n base stations or cells of a same coverage area. The network management system uniformly manages disablement or enablement of the n base stations or cells.

The base station or cell 1, the base station or cell 2, . . . , and the base station or cell n may belong to a network of a single standard and may also belong to multiple standard networks. The present invention is mainly directed to the situation that the base stations or cells belong to multiple standard networks. The situation that the base stations or cells belong to a network of a single standard belongs to the prior art, which is not described again here. When the base stations or cells belong to multiple standard networks, the situation is specifically: the base stations or cells access a network of different standards by using different radio access technologies (Radio Access Technologies, RATs). For example, the base station or cell 1 accesses a GSM standard network, the base station or cell 2 and the base station or cell 3 access a UMTS standard network, a base station or cell 4 accesses the GSM standard network and the UMTS standard network at the same time by using different RATs, and a base station or cell 5 accesses the GSM standard network, the UMTS standard network, and an LTE standard network at the same time by using different RATs. The base station or cell may also be a cell. With respect to a base station or cell belonging to the GSM standard network and the UMTS standard network, the base station or cell accesses the network management system through a base station or cell controller (Base Station Controller, BSC) or a radio network controller (Radio Network Controller, RNC).

Therefore, when energy conservation management is performed on the base stations or cells, it is necessary that the network management system integrates a whole traffic condition of the multiple standard networks assessed by the multiple base stations or cells, selects a proper base station or cell and performs energy conservation disablement processing on the base station or cell.

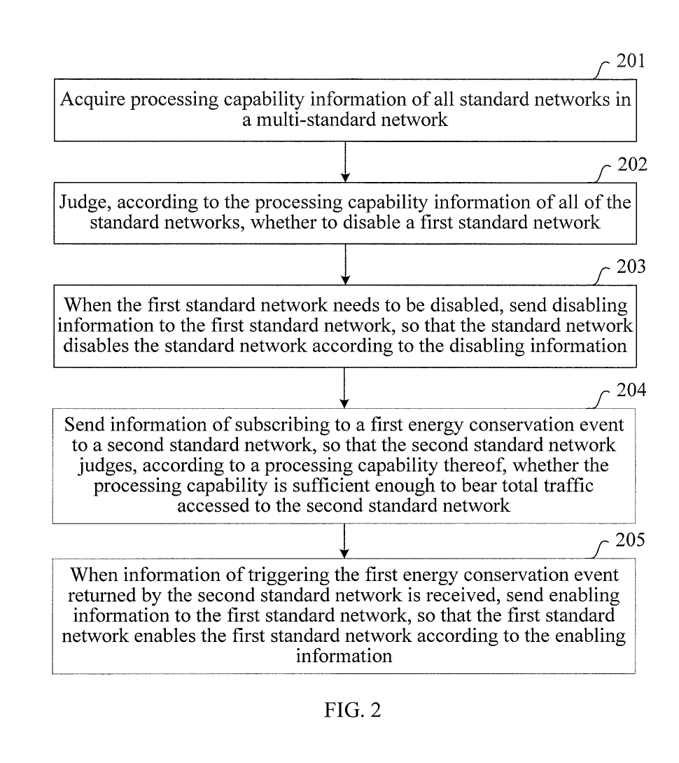

FIG. 2 is a flowchart of a method for disabling a standard network provided in Embodiment 2 of the present invention. As shown in FIG. 2, the embodiment of the present invention specifically includes the following steps:

Step 201: A network management system acquires processing capability information of all standard networks in a multi-standard network.

Specifically, the multi-standard network includes networks of two standards or more than two standards. For example, the standard network may be a network of an LTE standard, a UMTS standard, a GSM standard, and other standards.

Meanwhile, the processing capability information of each standard network in the multi-standard network may be statistic information of performance measurement data of each base station or cell in the standard network, and a topology structure of the base stations or cells and cells. The processing capability information specifically includes traffic information of the standard network, information of a proportion of user terminals with high priorities in a coverage area of the standard network, information of whether a single mode terminal of a specific standard is present in the coverage area of the standard network, information of the power consumption condition of the base stations or cells in the coverage area of the standard network, and the number of online users.

In addition, the processing capability information of each standard network further includes: the number of times for updating a message of a location area of user terminals covered by each base station or cell in each standard network.

Step 202: The network management system judges, according to the processing capability information of all of the standard networks, whether to disable a first standard network. The first standard network is a network that needs to be disabled.

Specifically, the manner of judging, by the network management system, whether to disable the first standard network is: ordering an energy conservation priority of disablement for each standard network in the multi-standard network according to the processing capability information of each standard network and preferentially disabling a standard network having a high energy conservation priority. For example, when the multi-standard network only has the LTE standard and the UMTS standard and it is determined that a standard network of a first energy conservation priority is the LTE standard, it is determined at the same time that the UMTS standard is a standard network of a second energy conservation priority. When the multi-standard network has three standards, including the LTE standard, the UMTS standard, and the GSM standard and it is determined that a standard network of a first energy conservation priority is the LTE standard and a standard network of a second energy conservation priority is the UMTS standard, it is determined at the same time that the GSM standard is a standard network of a third energy conservation priority. It may be deduced by analogy that priorities of disablement of all standards in the multi-standard network are ordered. The ordering the priorities of disablement refers to ordering a sequence for disabling all of the standard networks in the multi-standard network to determine a standard network which is the first to be preferentially disabled, a standard network which is the second to be preferentially disabled, and so on. After a standard network is disabled, the base station or cell where the standard network is located enters an energy conservation state. However, not all of the standard networks in the multi-standard network may be disabled. A standard network that cannot be disabled needs to be reserved, is provided for the user terminals and serves as a basic access standard network of the user terminals.

The following describes the process of judging, by the network management system, a standard network which needs to be disabled in the multi-standard network in detail.

When the traffic information in the processing capability information of each standard network in the multi-standard network is taken as a basis, that is, service traffic of the standard network is taken as a basis, an energy conservation priority of disablement of each standard network in the multi-standard network is ordered. The preferentially disabling a standard network with a higher energy conservation priority refers to preferentially choosing to disable a standard network with lower service traffic.

When the information of the proportion of the user terminals with high priorities in the coverage area of the standard network in the processing capability information of each standard network in the multi-standard network is taken as a basis to order the energy conservation priority of disablement for each standard network in the multi-standard network, if it is determined that the proportion of the user terminals with high priorities in the coverage area of the standard network is greater than a certain threshold, it is selected that the standard network cannot be disabled.

When the information of whether the single mode terminal of the single standard is present in the coverage area in the processing capability information of each standard network in the multi-standard network is taken as a basis to order the energy conservation priority of disablement for each standard network in the multi-standard network, if it is determined that the single mode terminal of a specific standard is present in the coverage area of the standard network, it is selected that the standard network cannot be disabled. For example, when it is determined that a terminal which only supports the LTE standard network is present, it is not taken into consideration to disable the LTE standard network.

When the information of the power consumption condition of the base stations or cells in the coverage area in the processing capability information of each standard network in the multi-standard network, that is, energy consumed per unit of service traffic, is taken as a basis to order the energy conservation priority of disablement for each standard network in the multi-standard network, a standard network with higher energy consumed per unit of service traffic is selected to be a standard network which is disabled preferentially, that is, a standard network with a highest energy conservation priority of disablement.

Step 203: When it is determined that the first standard network needs to be disabled, the network management system sends disabling information to the standard network, so that the standard network disables the standard network according to the disabling information. The disabling the first standard network is specifically: disabling the base station or cell of the standard network.

Specifically, the network management system preferentially needs to disable a standard network with a first disablement priority, sends disabling information to the standard network with the first disablement priority, and commands the standard network with the first disablement priority to enter the energy conservation state.

Furthermore, the network management system determines, according to the number of times for updating the message in the location area of the user terminals covered by the standard network in the processing capability information sent by the standard network which is determined as one that needs to be disabled, a specific disablement manner of the base station or cell in the standard network, adds the disablement manner into the disabling information, and sends the disabling information to the base station or cell in the standard network which needs to be disabled, so that the base station or cell in the standard network which needs to be disabled disables the base station or cell in a received disablement manner.

The process of determining the specific disablement manner is that: if the number of times for updating the message of the location area of the user terminals covered by the standard network is greater than a certain number threshold, the network management system determines that, in the user terminals covered by the standard network, the number of user terminals in an idle state is greater, so a manner of lowering down pilot power consumption of the base station or cell in the standard network step by step is used to disable the base station or cell in the standard network, and otherwise, the base station or cell where the standard network is located is directly disabled.

Step 204: The network management system sends information of subscribing to a first energy conservation event to a second standard network, so that the second standard network judges, according to a processing capability thereof, whether the processing capability is sufficient enough to bear total traffic accessed to the second standard network, where the second standard network is a standard network which is not disabled.

Specifically, the network management system obtains in real time, in a manner of sending information of subscribing to a first energy conservation event, whether the standard network which is not disabled is sufficient enough to bear the total traffic accessed to the standard network which is not disabled. The first energy conservation event refers to a request for enabling a disabled standard network.

After the standard network which is not disabled receives the information of subscribing to the first energy conservation event sent by the network management system, if the first energy conservation event is not triggered, it indicates that the standard network which is not disabled is capable of bearing the total traffic accessed to the standard network which is not disabled. If the first energy conservation event is triggered, it indicates that the standard network which is not disabled is incapable of bearing the total traffic accessed to the standard network which is not disabled. Many factors for determining that the standard network which is not disabled is incapable of bearing the total traffic accessed to the standard network which is not disabled are specifically in the following:

First, when the accessed total traffic is greater than a processing capability threshold of a local standard network, it is determined that the local standard network is incapable of bearing total traffic accessed to the local standard network.

Second, when a base station or cell in a local standard network is incapable of working, that is, is invalid, it is determined that the local standard network is incapable of bearing total traffic accessed to the local standard network.

In addition, when accessing of a user with high quality of service occurs, total traffic accessed to the local standard network is far greater than a processing capability threshold of the local standard network, and thereby it is determined that the local standard network is incapable of bearing the total traffic accessed to the local standard network. The user with high quality of service is a user with a higher priority which initiates a service of a high rate or a short delay, for example, a service of a video calling, an online high definition video, and the like.

Step 205: When information of triggering the first energy conservation event returned by the second standard network is received, the network management system sends enabling information to the first standard network, so that the first standard network enables the first standard network according to the enabling information. The second standard network is a standard network which is not disabled. The first standard network is a disabled standard network. The enabling the first standard network is specifically enabling a base station or cell in the first standard network.

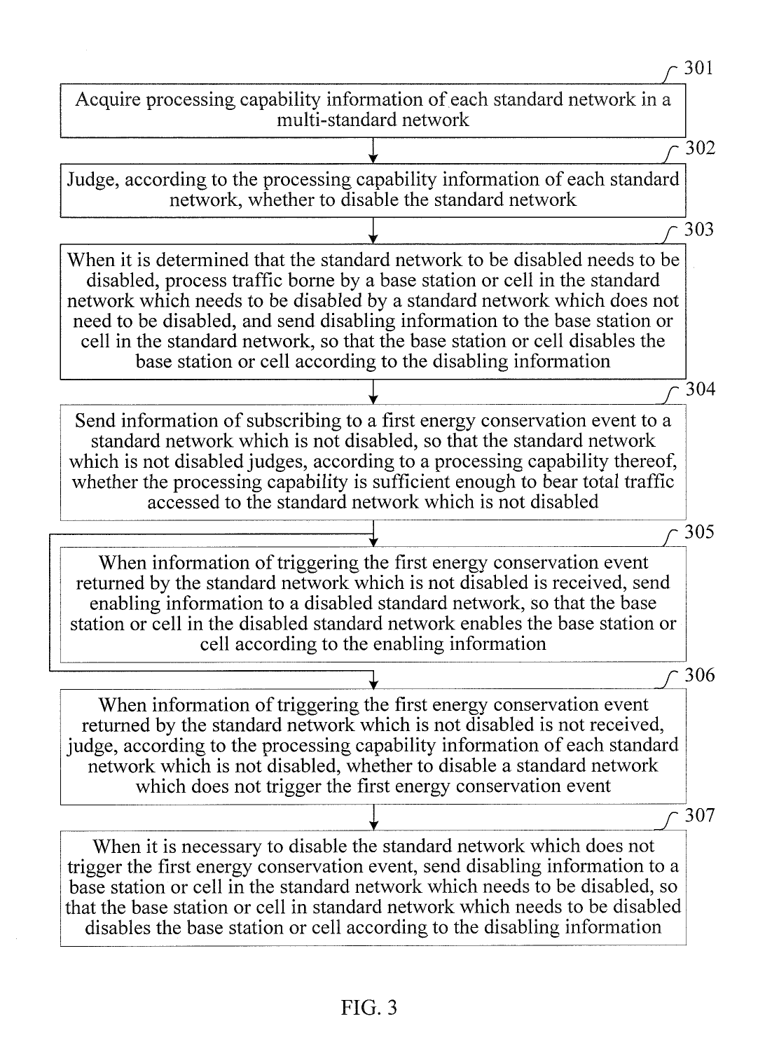

FIG. 3 is a flowchart of a method for disabling a standard network provided in Embodiment 3 of the present invention. As shown in FIG. 3, the embodiment of the present invention specifically includes the following steps:

Step 301 to step 305 are the same as step 201 to step 205, which are not specifically described here.

Step 306: When not receiving information of triggering the first energy conservation event returned by the second standard network, the network management system judges, according to the processing capability information of all of the standard networks in the multi-standard network, whether to disable the second standard network. The second standard network is a standard network which is not disabled. Specifically, when the multi-standard network only includes two standard networks, after a first standard network with a higher energy conservation priority of disablement is disabled, only a second standard network which is not disabled is left. When information of subscribing to a first energy conservation event is sent to the standard network which is not disabled, according to an actual situation that only one standard network which is not disabled is left at this time, the standard network cannot be disabled even if the standard network which is not disabled does not return information of triggering the first energy conservation event, because one standard network that cannot be disabled needs to be reserved, is provided for a user terminal and serves as a basic access standard network of the user terminal.

When the multi-standard network includes more than two standard networks, after a first standard network which needs to be disabled is disabled, if the number of the remaining second standard networks that are not disabled is more than two, the network management system sends information of subscribing to a first energy conservation event to the standard networks that are not disabled. When a certain standard network thereof does not return information of triggering the first energy conservation event and the standard network which does not trigger the first energy conservation event is not a sole standard network which is not disabled, the network management system judges, according to processing capability information of each standard network which is not disabled, whether to disable the standard network which does not trigger the first energy conservation event. Specifically, processing of a second priority is performed according to energy conservation priorities of disablement of all of the standard networks that are not disabled.

Step 307: When it is necessary to disable the second standard network, send disabling information to the second standard network, so that the second standard network disables the second standard network according to the disabling information. The disabling information carries a disablement manner of disabling the second standard network. A process of obtaining the disablement manner of the second standard network in step 307 is the same as the process of obtaining the disablement manner of the first standard network in step 203, which is not specifically described again here.

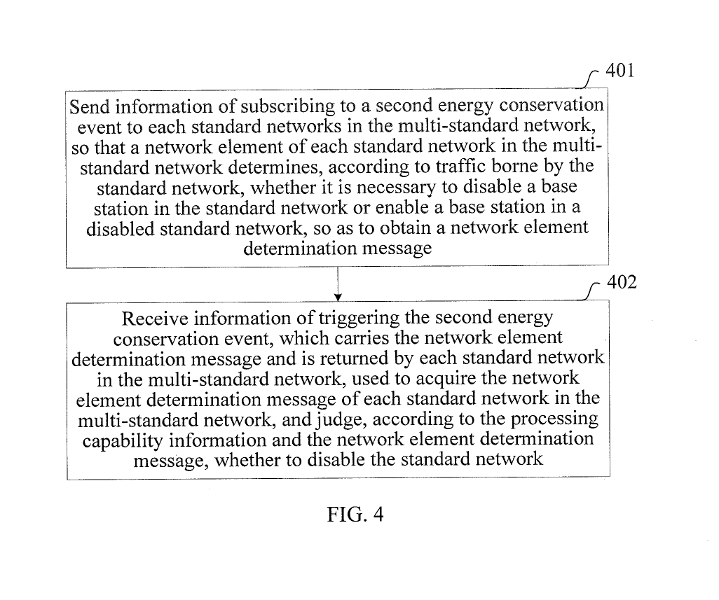

Preferentially, the method for disabling a standard network provided in Embodiment 2 and Embodiment 3 of the present invention further includes, as shown in FIG. 4:

Step 401: Send information of subscribing to a second energy conservation event to all of the standard networks in the multi-standard network, so that a network element of each standard network in the multi-standard network determines, according to traffic borne by the standard network, whether it is necessary to disable the standard network of the multi-standard network, so as to obtain a network element determination message of each standard network. The disabling the standard network is specifically: disabling a base station or cell of the standard network.

Specifically, the network element determination message obtained by the network element of each standard network is specifically as follows:

First, when the network element of each standard network in the multi-standard network determines, according to the traffic borne by the standard network, that it is necessary to disable the base station or cell in the standard network of the multi-standard network, the network element determination message is that the base station or cell in the standard network thereof is allowed to be disabled and to enter the energy conservation state. A determination principle is: when the network element of the standard network determines that the traffic or service borne by the base station or cell in the standard network is lower than a preset threshold, it is determined that the base station or cell in the standard network is allowed to be disabled.

Second, when the network element of each standard network in the multi-standard network determines, according to the traffic borne by the standard network, that the base station or cell in the standard network cannot be disabled, if the base station or cell in the standard network is not disabled, processing information of the standard network and the traffic borne by the standard network are compared to determine whether the standard network still has a capability of bearing more traffic or does not have a capability of bearing more traffic. When the standard network has the capability of bearing more traffic, it is allowed to disable a base station or cell in another standard network. At this time, the network element determination message is that the base station or cell in another standard network is allowed to be disabled and to enter the energy conservation state. When the standard network does not have the capability of bearing more traffic, at this time, the network element determination message is in an intermediate state, that is, neither allows the base station or cell of the standard network thereof to be disabled and to enter the energy conservation state, nor allows the base station or cell in another standard network to be disabled and to enter the energy conservation state.

Step 402: Receive information of triggering the second energy conservation event, which carries the network element determination message and is returned by each standard network in the multi-standard network, so as to acquire the network element determination message of each standard network in the multi-standard network, and judge, according to the processing capability information and the network element determination message, whether to disable the standard network.

Specifically, the network management system judges, not only according to the processing capability information of each standard network in the multi-standard network, but also in combination with the network element determination message of identifying each standard network by each standard network in the multi-standard network, whether to disable the standard network. The network element determination message refers to determining, by the network element of each standard network in the multi-standard network according to the traffic borne by the standard network, whether it is necessary to disable the base station or cell in the standard network.

Therefore, in the method for disabling a standard network provided in Embodiment 2, Embodiment 3, and Embodiment 4 of the present invention, the network management system judges, according to the acquired processing capability information of each standard network in the multi-standard network, or further in combination with the network element determination information, whether the standard network needs to be disabled, and when it is determined that the standard network needs to be disabled, sends the disabling information to the base station or cell in the standard network. In this manner, the network management system may uniformly coordinate and manage the disablement of the base station or cell where the multi-standard network is located. Meanwhile, the network management system identifies, in a manner of subscribing to an energy conservation event, whether a standard network which is not disabled is sufficient enough to bear traffic of a base station or cell in a disabled standard network, and if the standard network which is not disabled is incapable of bearing the traffic of the disabled base station or cell, sends enabling information to the base station or cell in the disabled standard network, so as to adapt to variations of services of the multi-standard network, and in particular, adapt to a burst service of the multi-standard network.

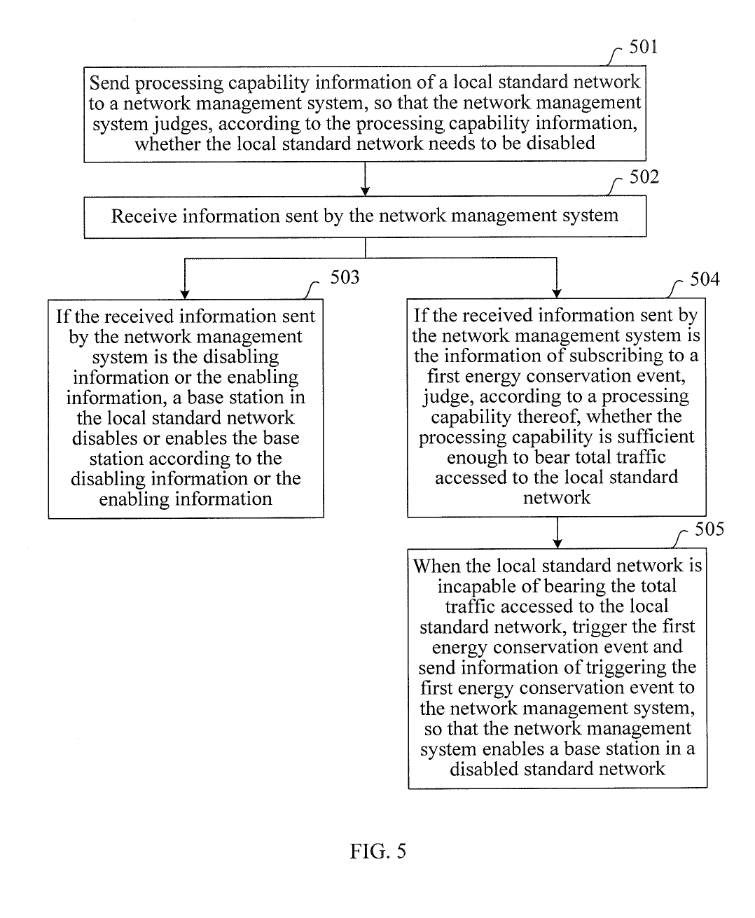

FIG. 5 is a flowchart of a method for disabling a standard network provided in Embodiment 5 of the present invention. As shown in FIG. 5, the embodiment of the present invention specifically includes the following steps:

Step 501: Send processing capability information of a local standard network to a network management system, so that the network management system judges, according to the processing capability information, whether the local standard network needs to be disabled.

Specifically, the processing capability information of the local standard network is statistic information of performance measurement data of the standard network, which includes historical statistic information of performance measurement data. The processing capability information specifically includes traffic information of the standard network, information of a proportion of user terminals with high priorities in a coverage area of the standard network, information of whether a single mode terminal of a specific standard is present in the coverage area of the standard network, and information of the power consumption condition of the base stations or cells in the coverage area of the standard network.

In addition, the processing capability information of the local standard network further includes: the number of times for updating a message of a location area of the user terminals covered by the local standard network, so that the network management system determines a specific disablement manner of the base station or cell in the local standard network.

Step 502: The local standard network receives information sent by the network management system. The information sent by the network management system is disabling information, enabling information, information of subscribing to a first energy conservation event, or information of subscribing to a second energy conservation event. The first energy conservation event refers to a request for enabling a disabled standard network.

Step 503: If the received information sent by the network management system is the disabling information or the enabling information, the base station or cell in the local standard network disables or enables the base station or cell according to the disabling information or the enabling information.

Specifically, when the disabling information sent by the network management system is received, the base station or cell in the local standard network disables the base station or cell according to the disabling information. The disabling information further includes the manner of disabling the base station or cell in the local standard network. The disablement manner is a disablement manner of lowering down power consumption step by step or a disablement manner of disabling directly, which is determined by the network management system according to the number of user terminals in an idle state of the base station or cell in the local standard network. When receiving the disabling information carrying the disablement manner, the base station or cell in the local standard network disables the base station or cell in a received disablement manner.

Step 504: If the received information sent by the network management system is the information of subscribing to a first energy conservation event, judge, according to a processing capability thereof, whether the processing capability is sufficient enough to bear total traffic accessed to the local standard network.

Specifically, many factors for determining that the standard network which is not disabled is incapable of bearing the total traffic accessed to the local standard network are specifically in the following. First, when the accessed traffic is greater than a processing capability threshold of the local standard network, it is determined that the local standard network is incapable of bearing total traffic accessed to the local standard network. Second, when the base station or cell in the local standard network is incapable of working, that is, is invalid, it is determined that the local standard network is incapable of bearing the total traffic accessed to the local standard network. In addition, when accessing of a user with high quality of service occurs, that is, when a user terminal exceeding the processing capability of the local standard network accesses to the local standard network, it is determined that the local standard network is incapable of bearing the total traffic accessed to the local standard network. The user with high quality of service is a user with a higher priority which initiates a service of a high rate or a short delay, for example, a service of a video calling, an online high definition video, and the like.

Step 505: When the local standard network is incapable of bearing the total traffic accessed to the local standard network, trigger the first energy conservation event and send information of triggering the first energy conservation event to the network management system, so that the network management system enables a disabled standard network. The enabling the disabled standard network is specifically: enabling a base station or cell of the disabled standard network.

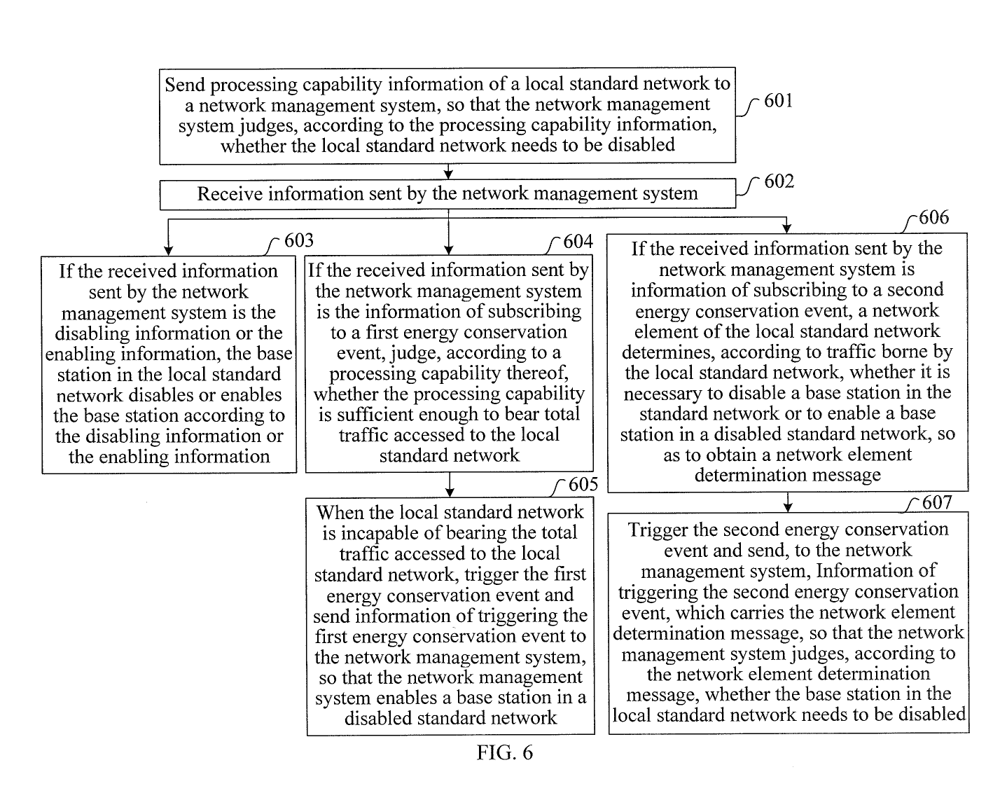

FIG. 6 is a flowchart of a method for disabling a standard network provided in Embodiment 6 of the present invention. As shown in FIG. 6, the embodiment of the present invention specifically includes the following steps:

Step 601 to step 605 are the same as step 501 to step 505, which are not specifically described here.

Step 606: If the received information sent by the network management system is information of subscribing to a second energy conservation event, a network element of the local standard network determines, according to traffic borne by the local standard network, whether it is necessary to disable the local standard network, so as to obtain a network element determination message. The network element determination message is that the base station or cell in the standard network is allowed to be disabled and to enter the energy conservation state, or a base station or cell in another standard network is allowed to be disabled and to enter the energy conservation state or an intermediate state.

Specifically, the network element determination message obtained by the network element of the local standard network is specifically as follows:

First, when the network element of the local standard network determines, according to the traffic borne by the local standard network, that it is necessary to disable the base station or cell in the standard network, the network element determination message is that the base station or cell in the standard network thereof is allowed to be disabled and to enter the energy conservation state. A determination principle is: when the network element of the local standard network determines that the traffic or service borne by the base station or cell in the local standard network is lower than a preset threshold, it is determined that the base station or cell in the local standard network is allowed to be disabled.

Second, when the network element of the local standard network determines, according to the traffic borne by the local standard network, that the base station or cell in the standard network cannot be disabled, if the base station or cell in the standard network is not disabled, processing information of the standard network and the traffic borne by the standard network are compared to determine whether the standard network still has a capability of bearing more traffic or does not have a capability of bearing more traffic. When the standard network has the capability of bearing more traffic, it is allowed to disable a base station or cell in another standard network. At this time, the network element determination message is that the base station or cell in another standard network is allowed to be disabled and to enter the energy conservation state. When the standard network does not have the capability of bearing more traffic, at this time, the network element determination message is in an intermediate state, that is, neither allows the base station or cell of the standard network thereof to be disabled and to enter the energy conservation state, nor allows the base station or cell in another standard network to be disabled and to enter the energy conservation state.

Step 607: Trigger the second energy conservation event and send, to the network management system, information of triggering the second energy conservation event, which carries the network element determination message, so that the network management system judges, according to the network element determination message, whether the local standard network needs to be disabled. The judging whether the local standard network needs to be disabled is specifically judging whether a base station or cell in the local standard network needs to be disabled.

Specifically, the network management system judges, not only according to the processing capability information of the local standard network, but also in combination with network element determination information of judging the local standard network by a network element of the local standard network, whether to disable the standard network.

Therefore, in the method for disabling a standard network provided in Embodiment 5 of the present invention and Embodiment 6 of the present invention, the local standard network sends, to the network management system, the local processing capability information, or the local processing capability information and the local network element determination information, so that the network management system determines whether the standard network needs to be disabled, receives the disabling information sent by the network management system, and disables the base station or cell in the local standard network according to the disabling information, so as to implement that the network management system uniformly coordinates and manages the disablement of the base station or cell where the multi-standard network is located. Meanwhile, when the local standard network is incapable of bearing the traffic of the base station or cell in a disabled standard network, or when accessing of a user terminal with high quality of service occurs, the local standard network notifies the network management system and requests the network management system to enable a base station or cell in a disabled standard network, so as to adapt to variations of services of the multi-standard network, and in particular, adapt to a burst service of the multi-standard network.

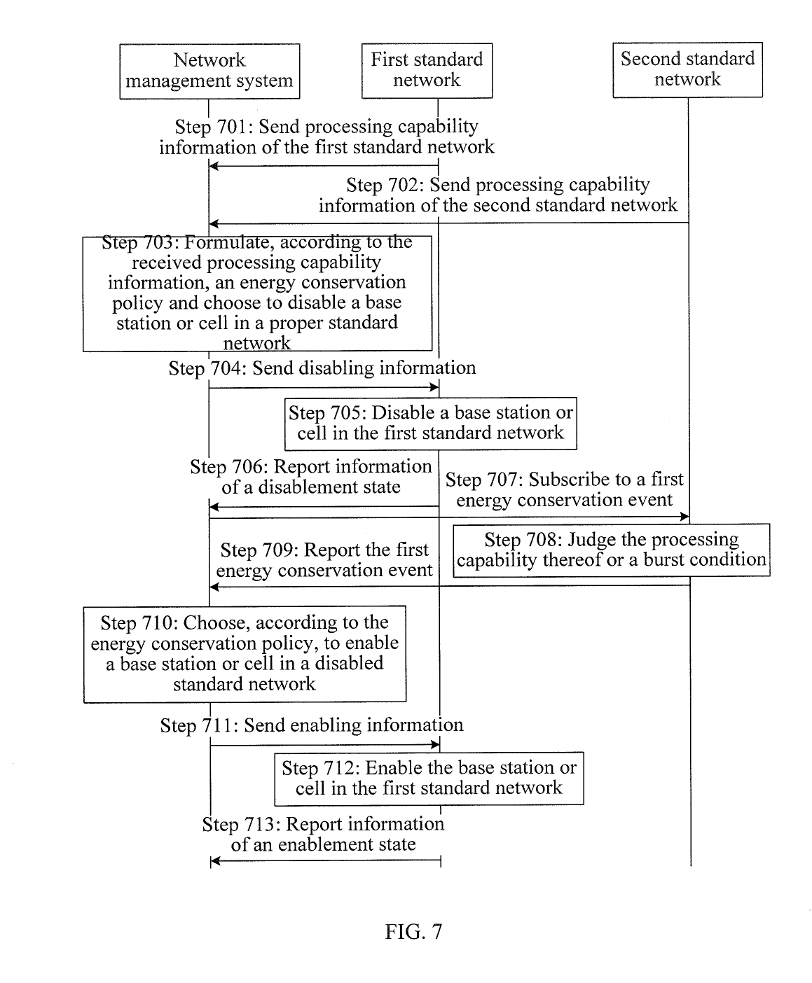

FIG. 7 is a diagram of information exchange of a method for disabling a standard network provided in Embodiment 7 of the present invention. The embodiment of the present invention includes a network management system, a first standard network, and a second standard network. The embodiment of the present invention takes two standard networks as an example to describe a process of uniformly managing and coordinating the first standard network and the second standard network by the network management system. As shown in FIG. 7, the embodiment of the present invention specifically includes the following steps:

Step 701: The first standard network sends processing capability information thereof to the network management system.

Step 702: The second standard network sends processing capability information thereof to the network management system.

Step 703: The network management system formulates, according to the received processing capability information of the first standard network and that of the second standard network, an energy conservation policy and chooses to disable a base station or cell in a proper standard network.

Specifically, the network management system formulates an energy conservation policy of a multi-standard network. The multi-standard network only includes the first standard network and the second standard network. The first standard network and the second standard network are two standard networks belonging to a same coverage area. The area which is covered by base stations or cells belongs to the two standard networks. A principle of formulating the energy conservation policy of the multi-standard network is ordering priorities of disablement of multiple standard networks and preferentially disabling a standard network with a higher priority. In addition, choosing to disable the base station or cell in the proper standard network is judging whether to disable the base station or cell in the first standard network or to disable the base station or cell in the second standard network. Moreover, according to that the priority of disablement of the first standard network is higher than the priority of disablement of the second standard network, it is therefore determined that the base station or cell in the first standard network is disabled and meanwhile the traffic of the base station or cell in the first standard network is borne by the base station or cell in the second standard network.

Step 704: The network management system sends disabling information to the first standard network. The disabling information carries a disablement manner for disabling the base station or cell in the first standard network.

Step 705: The base station or cell in the first standard network, after receiving the disabling information, disables the base station or cell in the disablement manner carried in the disabling information.

Step 706: The base station or cell in the first standard network reports information of a disablement state to the network management system to notify the network management system of the current state of the base station or cell in the standard network.

Step 707: The network management system sends information of a first subscription event to the second standard network, so as to judge whether the second standard network is sufficient enough to bear the traffic of the base station or cell in the disabled first standard network.

Step 708: The second standard network judges, according to a processing capability of the second standard network, whether the processing capability is sufficient enough to bear the total traffic accessed to the second standard network, and when the local standard network is incapable of bearing the total traffic accessed to the local standard network, requests the network management system to enable the base station or cell in the disabled first standard network.

Step 709: The second standard network reports a message of a first energy conservation event to the network management system, that is, makes a request for enabling the base station or cell in the disabled standard network.

Step 710: The network management system chooses, according to the received message of the first energy conservation event reported by the second standard network to the network management system and in combination with the priority of the disabled standard network, to enable a base station or cell in a disabled standard network with a lowest priority. In the embodiment of the present invention, only the first standard network is the disabled standard network, so it is decided to enable the base station or cell in the disabled first standard network.

Step 711: Send enabling information to the base station or cell in the disabled first standard network.

Step 712: The base station or cell in the first standard network enables the base station or cell according to the received enabling information.

Step 713: The base station or cell in the first standard network, after being enabled, reports information of an enablement state to the network management system to notify the network management system of the current state of the base station or cell in the standard network.

Apart from the above, the multi-standard network may further include another standard network in the same coverage area in addition to the first standard network and the second standard network, but the method for information exchange between the network management system and the multi-standard network is basically the same as the method for information exchange between the network management system and the first standard network as well as the second standard network. The situation of more than two standard networks is not described in detail here.

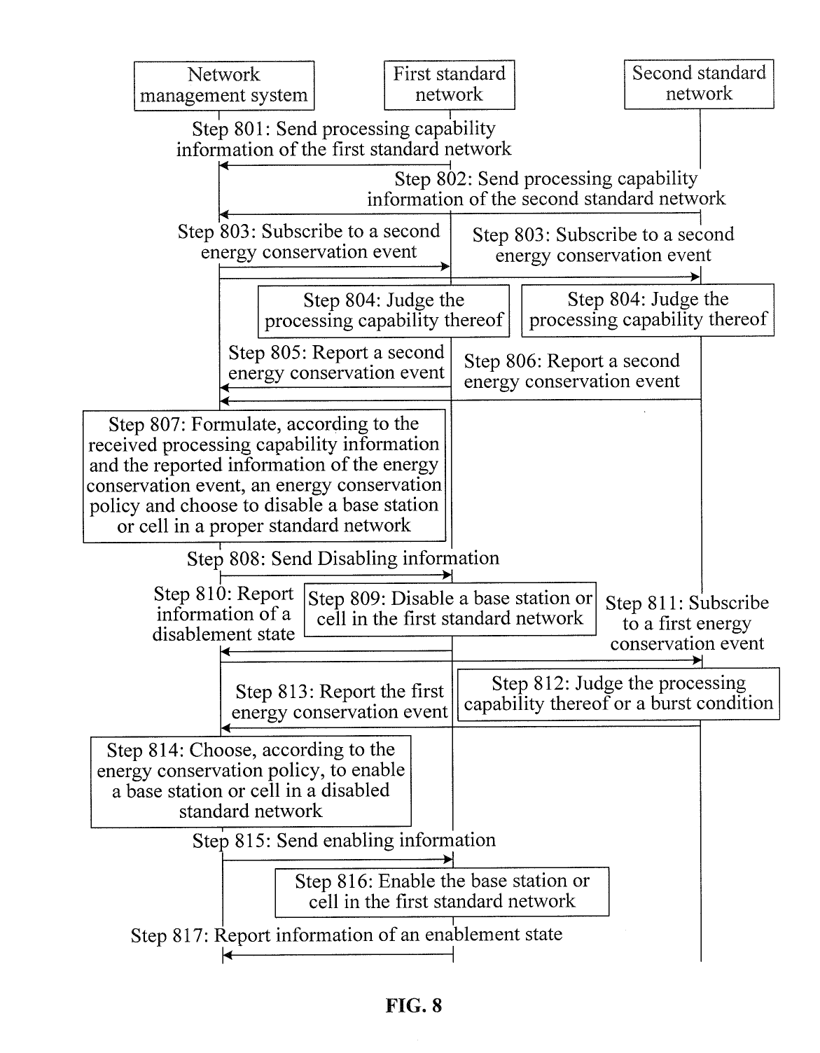

FIG. 8 is a diagram of information exchange of a method for disabling a standard network provided in Embodiment 8 of the present invention. The embodiment of the present invention includes a network management system, a first standard network, and a second standard network. The embodiment of the present invention takes two standard networks as an example to describe a process of uniformly managing and coordinating the first standard network and the second standard network by the network management system. As shown in FIG. 8, the embodiment of the present invention specifically includes the following steps:

Step 801 and step 802 are the same as step 701 and step 702, which are not described in detail here.

Step 803: The network management system sends information of subscribing to a second energy conservation event to the first standard network and the second standard network. A purpose is to enable a network element of the first standard network and that of the second standard network to determine, according to traffic borne by the first standard network and by the second standard network, whether it is necessary to disable a base station or cell of the local standard network, so that the network management system chooses, not only according to the processing capability information of the first standard network and that of the second standard network, but also with reference to a network element determination message of the first standard network and that of the second standard network, to disable a base station or cell in a proper standard network.

Step 804: The network element of the first standard network and that of the second standard network determine, according to the traffic borne by the local standard network, whether it is necessary to disable the base station or cell in the local standard network, so as to obtain a network element determination message.

Step 805: The first standard network, after performing self-judgment, reports information of the second energy conservation event, which carries the network element determination message, that is, feeds back the network element determination message to the network management system. For example, the network element determination information is that disabling the first standard network is allowed.

Step 806: The second standard network, after performing self-judgment, reports information of an energy conservation event, that is, feeds back the network element determination message to the network management system. For example, the network element determination information is that disabling the first standard network is allowed.

Step 807: The network management system formulates, according to the network element determination message of the first standard network and that of the second standard network and the processing capability information of the first standard network and that of the second standard network, an energy conservation policy, and chooses to disable a base station or cell in a proper standard network.

Specifically, the network management system formulates an energy conservation policy of a multi-standard network. The multi-standard network only includes the first standard network and the second standard network. The first standard network and the second standard network are two standard networks belonging to a same coverage area. Base stations or cells covering the area respectively belong to the two standard networks. A principle of formulating the energy conservation policy of the multi-standard network is ordering priorities of disablement according to the network element determination message of the first standard network and that of the second standard network and the processing capability information of the first standard network and that of the second standard network and preferentially disabling a standard network with a higher priority. In addition, the choosing to disable the base station or cell in the proper standard network is judging whether to disable the base station or cell in the first standard network or to disable the base station or cell in the second standard network. Moreover, according to that the priority of disablement of the first standard network is higher than the priority of disablement of the second standard network, it is therefore determined that the base station or cell in the first standard network is disabled and meanwhile the traffic of the base station or cell in the first standard network is borne by the base station or cell in the second standard network.

Step 808 to step 817 are the same as step 704 to step 713, which are not described in detail here.

Additionally, the multi-standard network may further include another standard network in the same coverage area in addition to the first standard network and the second standard network, but the method for information exchange between the network management system and the multi-standard network is basically the same as the method for information exchange between the network management system and the first standard network as well as the second standard network. The situation of more than two standard networks is not described in detail here.

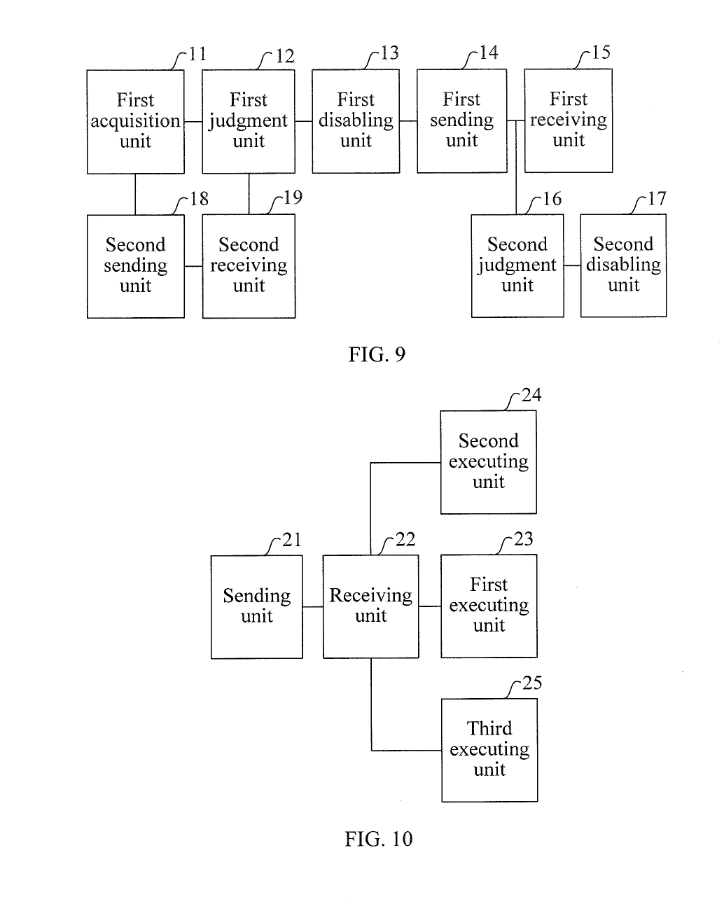

FIG. 9 is a schematic diagram of an apparatus for disabling a standard network provided in Embodiment 9 of the present invention. The apparatus is a device for executing the method for disabling a standard network provided in Embodiment 2, Embodiment 3, and Embodiment 4. The device may be various devices capable of implementing the method for disabling a standard network, for example, a network management device. As shown in FIG. 9, the apparatus for disabling a standard network provided in the embodiment of the present invention specifically includes: a first acquisition unit 11, a first judgment unit 12, first disabling unit 13, a first sending unit 14, and a first receiving unit 15.

The first acquisition unit 11 is configured to acquire processing capability information of all standard networks in a multi-standard network. The first judgment unit 12 is configured to judge, according to the processing capability information of all of the standard networks, whether to disable a first standard network. The first disabling unit 13 is configured to: when it is necessary to disable the first standard network, send disabling information to the standard network, so that the first standard network disables the first standard network according to the disabling information. The first sending unit 14 is configured to send information of subscribing to a first energy conservation event to a second standard network, so that the second standard network judges, according to a processing capability thereof, whether the processing capability is sufficient enough to bear total traffic accessed to the second standard network. The first receiving unit 15 is configured to: when information of triggering the first energy conservation event returned by the second standard network is received, send enabling information to the first standard network, so that the first standard network enables the first standard network according to the enabling information.

Specifically, in the first acquisition unit 11, the multi-standard network includes networks of two standards or more than two standards. In the multi-standard network, the processing capability information of each standard network is statistic information of performance measurement data of the standard network, which includes historical statistic information of performance measurement data. The processing capability information specifically includes traffic information of the standard network, information of a proportion of user terminals with high priorities in a coverage area of the standard network, information of whether a single mode terminal of a specific standard is present in the coverage area of the standard network, and information of the power consumption condition of the base stations or cells in the coverage area of the standard network. In addition, the processing capability information of each standard network further includes the number of times for updating a message of a location area of user terminals covered by each standard network.

In the first judgment unit 12, when the traffic information in the processing capability information of each standard network in the multi-standard network is taken as a basis, that is, service traffic of the standard network is taken as a basis, a standard network with lower service traffic is preferentially selected to be disabled. When the information of the proportion of the user terminals with high priorities in the coverage area of the standard network in the processing capability information of each standard network in the multi-standard network is taken as a basis, a standard network to be preferentially disabled is selected according to a configuration of the user terminals with high priorities. When the information of whether the single mode terminal of the single standard is present in the coverage area in the processing capability information of each standard network in the multi-standard network is taken as a basis and if it is determined that the single mode terminal of a specific standard is present in the coverage area of the standard network, the standard network cannot be selected to be disabled. When the information of the power consumption condition of the base stations or cells in the coverage area in the processing capability information of each standard network in the multi-standard network, that is, energy consumed per unit of service traffic, is taken as a basis, a standard network with higher energy consumed per unit of service traffic is selected as the standard network to be preferentially disabled.

In the first disabling unit 13, the network management system determines a specific disablement manner of the base station or cell in the standard network according to the number of times for updating the message in the location area of the user terminals covered by the standard network in the processing capability information sent by the standard network which is determined as one that needs to be disabled, adds the disablement manner into the disabling information, and sends the disabling information to the base station or cell in the standard network which needs to be disabled, so that the base station or cell in the standard network which needs to be disabled disables the base station or cell in the received disablement manner. The process of determining the specific disablement manner is that: if the number of times for updating the message of the location area of the user terminals covered by the standard network is greater than a certain number threshold, the network management system determines that, in the user terminals covered by the standard network, the number of user terminals in an idle state is greater, so a manner of lowering down pilot power consumption of the base station or cell in the standard network step by step is used to disable the base station or cell/cell in the standard network, and otherwise, the base station or cell where the standard network is located is directly disabled.

Preferentially, the apparatus for disabling a standard network provided in the embodiment of the present invention further includes: a second judgment unit 16 and a second disabling unit 17.

The second judgment unit 16 is configured to: when information of triggering the first energy conservation event returned by the second standard network is not received, judge, according to the processing capability information of all of the standard networks in the multi-standard network, whether to disable the second standard network. The second disabling unit 17 is configured to: when it is necessary to disable the second standard network, send disabling information to the second standard network, so that the standard network which needs to be disabled disables the standard network according to the disabling information.

Further preferentially, the apparatus for disabling a standard network provided in the embodiment of the present invention further includes: a second sending unit 18 and a second receiving unit 19. The second sending unit 18 is configured to send information of subscribing to a second energy conservation event to all of the standard networks in the multi-standard network, so that a network element of each standard network in the multi-standard network determines, according to traffic borne by the standard network, whether to disable the standard network, so as to obtain a network element determination message. The second receiving unit 19 is configured to receive information of triggering the second energy conservation event, which carries the network element determination message and is returned by each standard network in the multi-standard network, so as to acquire the network element determination message of each standard network in the multi-standard network, and judge, according to the processing capability information and the network element determination message, whether to disable the first standard network.

Therefore, in the apparatus for disabling a standard network provided in Embodiment 9 of the present invention, the network management system judges, according to the acquired processing capability information of each standard network in the multi-standard network, or according to the acquired processing capability information of each standard network in the multi-standard network and the network element determination information, whether the standard network needs to be disabled, and when it is determined that the standard network needs to be disabled, sends the disabling information to the base station or cell in the standard network. In this manner, the network management system may uniformly coordinate and manage the disablement of the base station or cell where the multi-standard network is located. Meanwhile, the network management system identifies, in a manner of subscribing to an energy conservation event, whether a standard network which is not disabled is sufficient enough to bear traffic of a base station or cell in a disabled standard network, and if the standard network which is not disabled is incapable of bearing the traffic of the disabled base station or cell, sends enabling information to the base station or cell in the disabled standard network. The apparatus adapts to the variations of services of the multi-standard network, and in particular, adapts to a burst service of the multi-standard network.

FIG. 10 is a schematic diagram of an apparatus for disabling a standard network provided in Embodiment 10 of the present invention. The apparatus is a device for executing the method for disabling a standard network provided in Embodiment 5 and Embodiment 6. The device may be various devices capable of implementing the method for disabling a standard network, for example, a base station or cell. As shown in FIG. 10, the apparatus for disabling a standard network provided in the embodiment of the present invention specifically includes: a sending unit 21, a receiving unit 22, a first executing unit 23, and a second executing unit 24.

The sending unit 21 is configured to send processing capability information of a local standard network to a network management system, so that the network management system judges, according to the processing capability information, whether the local standard network needs to be disabled. The receiving unit 22 is configured to receive information sent by the network management system. The first executing unit 23 is configured in that if the received information sent by the network management system is disabling information or enabling information, the local standard network disables or enables the local standard network according to the disabling information or the enabling information. The second executing unit 23 is configured to: if the received information sent by the network management system is information of subscribing to a first energy conservation event, judge, according to a processing capability of the local standard network, whether the processing capability is sufficient enough to bear total traffic accessed to the local standard network, and when the local standard network is incapable of bearing the total traffic accessed to the local standard network, trigger the first energy conservation event and send information of triggering the first energy conservation event to the network management system, so that the network management system enables a disabled standard network.

Specifically, in the sending unit 21, the processing capability information of the local standard network is statistic information of performance measurement data of the standard network, which includes historical statistic information of performance measurement data. The processing capability information specifically includes traffic information of the standard network, information of a proportion of user terminals with high priorities in a coverage area of the standard network, information of whether a single mode terminal of a specific standard is present in the coverage area of the standard network, and information of the power consumption condition of the base stations or cells in the coverage area of the standard network. In addition, the processing capability information of the local standard network further includes: the number of times for updating a message of a location area of the user terminals covered by the local standard network, so that the network management system determines a specific disablement manner of the base stations or cells in the local standard network.

The disabling information in the receiving unit 22 further includes the manner of disabling the base station or cell in the local standard network. The disablement manner is a disablement manner of lowering down power consumption step by step or a disablement manner of disabling directly and is determined by the network management system according to the number of user terminals in an idle state of the base station or cell in the local standard network. When receiving the disabling information carrying the disablement manner, the base station or cell in the local standard network disables the base station or cell in the received disablement manner.

Preferentially, the apparatus for disabling a standard network provided in the embodiment of the present invention further includes a third executing unit 25.

The third executing unit 25 is configured in that if the received information sent by the network management system is information of subscribing to a second energy conservation event, a network element of the local standard network judges, according to traffic borne by the local standard network, whether it is necessary to disable the standard network, so as to obtain a network element determination message, and configured to trigger the second energy conservation event and send, to the network management system, information of triggering the second energy conservation event, which carries the network element determination message, so that the network management system judges, according to the network element determination message, whether the local standard network needs to be disabled.

Therefore, in the apparatus for disabling a standard network provided in Embodiment 10 of the present invention, the local standard network sends, to the network management system, the local processing capability information, or the local processing capability information and the network element determination information, so that the network management system determines whether the standard network needs to be disabled, receives the disabling information sent by the network management system, and disables the base station or cell in the local standard network according to the disabling information, so as to implement that the network management system uniformly coordinates and manages the disablement of the base station or cell where the multi-standard network is located. Meanwhile, when the local standard network is incapable of bearing the traffic of the base station or cell in a disabled standard network, or when accessing of a user terminal with high quality of service occurs, the local standard network notifies the network management system and requests the network management system to enable a base station or cell in a disabled standard network. The apparatus adapts to the variations of services of the multi-standard network, and in particular, adapts to a burst service of the multi-standard network.

An embodiment of the present invention further provides a system for disabling a standard network. The system for disabling a standard network includes: the apparatus for disabling a standard network in Embodiment 9 of the present invention and multiple apparatuses for disabling a standard network in Embodiment 10 of the present invention. For example, the system for disabling a standard network includes a network management device, multiple base stations or cells. The multiple base stations or cells belong to multiple standard networks.

Persons skilled in the art may further appreciate that, in combination with the examples described in the examples described in the embodiments herein, units and algorithm steps may be implemented by electronic hardware, computer software, or a combination thereof. In order to clearly describe the interchangeability between the hardware and the software, the foregoing has generally described compositions and steps of every embodiment according to functions. Whether the functions are executed by hardware or software depends on particular applications and design constraint conditions of the technical solutions. Persons skilled in the art may use different methods to implement the described functions for every particular application, but it should not be considered that the implementation goes beyond the scope of the present invention.

The steps of a method or algorithm described in connection with the embodiments disclosed here may be embodied directly in hardware, in a software module executed by a processor, or in a combination of the two. The software module may be located in a Random Access Memory (RAM), an internal memory, a Read Only Memory (ROM), an Electrically Programmable Read Only Memory (EPROM), an Electrically Erasable Programmable Read Only Memory (EEPROM), a register, a hard disk, a removable disk, a Compact Disk-Read Only Memory (CD-ROM), or any other storage media well-known in the art.

The objectives, technical solutions, and benefits of the present invention are further described in detail in the foregoing embodiments. It should be understandable that the foregoing embodiments are only specific embodiments of the present invention rather than being intended to limit the protection scope of the present invention. Any modification, equivalent replacement, or improvement made to the embodiments of the present invention without departing from the spirit and principles of the present invention shall fall into the protection scope of the present invention.

What is claimed is:

1. A method for disabling a standard network, comprising:
acquiring processing capability information of all standard networks in a multi-standard network;
judging, according to the processing capability information of all of the standard networks, whether to disable a first standard network;
when it is necessary to disable the first standard network, sending disabling information to the first standard network, so that the first standard network disables the first standard network according to the disabling information;
sending information of subscribing to a first energy conservation event to a second standard network, so that the second standard network judges, according to a processing capability thereof, whether the processing capability is sufficient enough to bear total traffic accessed to the second standard network; and
when information of triggering the first energy conservation event returned by the second standard network is received, sending enabling information to the first standard network, so that the first standard network enables the first standard network according to the enabling information.

2. The method for disabling a standard network according to claim 1, wherein after the sending the information of subscribing to a first energy conservation event to the second standard network, the method further comprises:
when the information of triggering the first energy conservation event returned by the second standard network is not received, judging, according to the processing capability information of all of the standard networks in the multi-standard network, whether to disable the second standard network; and
when it is necessary to disable the second standard network, sending disabling information to the second standard network, so that the second standard network disables the second standard network according to the disabling information.

3. The method for disabling a standard network according to claim 1, wherein after the acquiring the processing capability information of each standard network in the multi-standard network, the method further comprises:
sending information of subscribing to a second energy conservation event to all of the standard networks in the multi-standard network, so that a network element of each standard network in the multi-standard network determines, according to traffic borne by the standard network, whether it is necessary to disable the standard network, so as to obtain a network element determination message; and
receiving information of triggering the second energy conservation event, which carries the network element determination message and is returned by each standard network in the multi-standard network, so as to acquire the network element determination message of each standard network in the multi-standard network, and judging, according to the processing capability information and the network element determination message, whether to disable the first standard network.

4. The method for disabling a standard network according to claim 1, wherein the disabling information further comprises a disablement manner, the disablement manner is a disablement manner of lowering down power consumption step by step or a disablement manner of disabling directly, and is determined according to the first standard network, so that the first standard network disables the first standard network in the disablement manner.

5. The method for disabling a standard network according to claim 4, wherein the disablement manner of lowering down power consumption step by step or the disablement manner of disabling directly, which is determined according to the first standard network is:
when the number of times for updating a message in a location area of user terminals covered by the first standard network is greater than a preset number threshold, determining to use a disablement manner of lowering down power consumption of the first standard network step by step; and
when the number of times for updating the message of the location area of the user terminals covered by the first standard network is less than or equal to the preset number threshold, determining to use the disablement manner of disabling directly.

6. The method for disabling a standard network according to claim 1, wherein the judging, by the second standard network according to the processing capability thereof, whether the processing capability is sufficient enough to bear the total traffic accessed to the second standard network is:
when the accessed traffic is greater than a processing capability threshold of the second standard network, when the second standard network is incapable of working, or when a user terminal exceeding the processing capability of the second standard network accesses the second standard network, determining that the second standard network is incapable of bearing the total traffic accessed to the second standard network.

7. An apparatus for disabling a standard network, comprising:
a processor and a memory coupled to the processor, a receiver, and a sender;
wherein the receiver is configured to acquire processing capability information of all standard networks in a multi-standard network;
the processor is configured to judge, according to the processing capability information of all of the standard networks, whether to disable a first standard network;
the sender is configured to: when it is necessary to disable the first standard network, send disabling information to the first standard network, so that the first standard network disables the first standard network according to the disabling information; and send information of subscribing to a first energy conservation event to a second standard network, so that the second standard network judges, according to a processing capability thereof, whether the processing capability is sufficient enough to bear total traffic accessed to the second standard network; and
the sender is also configured to: when information of triggering the first energy conservation event returned by the second standard network is received, send enabling information to the first standard network, so that the first standard network enables the first standard network according to the enabling information.

8. The apparatus for disabling a standard network according to claim 7, wherein
the processor is configured to: when the information of triggering the first energy conservation event returned by the second standard network is not received, judge, according to the processing capability information of all of the standard networks in the multi-standard network, whether to disable the second standard network; and
the sender is configured to: when it is necessary to disable the second standard network, send disabling information to the second standard network, so that the second standard network disables the second standard network according to the disabling information.

9. The apparatus for disabling a standard network according to claim 7, wherein
the sender is configured to send information of subscribing to a second energy conservation event to all of the standard networks in the multi-standard network, so that a network element of each standard network in the multi-standard network determines, according to traffic borne by the standard network, whether it is necessary to disable the standard network, so as to obtain a network element determination message; and
the receiver is configured to receive information of triggering the second energy conservation event, which carries the network element determination message and is returned by each standard network in the multi-standard network, so as to acquire the network element determination message of each standard network in the multi-standard network, and judge, according to the processing capability information and the network element determination message, whether to disable the first standard network.

10. The apparatus for disabling a standard network according to claim 7, wherein the disabling information further comprises a disablement manner, the disablement manner is a disablement manner of lowering down power consumption step by step or a disablement manner of disabling directly and is determined according to the first standard network, so that the first standard network disables the first standard network in the disablement manner.

11. The apparatus for disabling a standard network according to claim 10, wherein the disablement manner of lowering down power consumption step by step or the disablement manner of disabling directly, which is determined according to the first standard network is:
when the number of times for updating a message in a location area of user terminals covered by the first standard network is greater than a preset number threshold, determining to use a disablement manner of lowering down power consumption of a base station or cell in the standard network step by step; and
when the number of times for updating the message of the location area of the user terminals covered by the first standard network is less than or equal to the preset number threshold, determining to use the disablement manner of disabling directly.

12. The apparatus for disabling a standard network according to claim 7, wherein the judging, by the second standard network according to the processing capability thereof, whether the processing capability is sufficient enough to bear the total traffic accessed to the second standard network is:
when the accessed traffic is greater than a processing capability threshold of the second standard network, when the second standard network is incapable of working, or when a user terminal exceeding the processing capability of the second standard network accesses the second standard network, determining that the second standard network is incapable of bearing the total traffic accessed to the second standard network.

13. An apparatus for disabling a standard network, comprising:
a processor and a memory coupled to the processor, a receiver, and a sender;
the sender is configured to send processing capability information of a local standard network to a network management system, so that the network management system judges, according to the processing capability information, whether the local standard network needs to be disabled;
the receiver is configured to receive information sent by the network management system;
the processor is configured in that if the received information sent by the network management system is disabling information or enabling information, the local standard network disables or enables the local standard network according to the disabling information or the enabling information; and if the received information sent by the network management system is information of subscribing to a first energy conservation event, judge, according to a processing capability of the local standard network, whether the processing capability is sufficient enough to bear total traffic accessed to the local standard network; and when the local standard network is incapable of bearing the total traffic accessed to the local standard network, trigger the first energy conservation event and send information of triggering the first energy conservation event to the network management system, so that the network management system enables a disabled standard network.

14. The apparatus for disabling a standard network according to claim 13, wherein
the processor is configured in that if the received information sent by the network management system is information of subscribing to a second energy conservation event, a network element of the local standard network judges, according to traffic borne by the local standard network, whether it is necessary to disable the standard network, so as to obtain a network element determination message; and configured to trigger the second energy conservation event and send, to the network management system, information of triggering the second energy conservation event, which carries the network element determination message, so that the network management system judges, according to the network element determination message, whether the local standard network needs to be disabled.

15. The apparatus for disabling a standard network according to claim 13, wherein the judging, according to the processing capability thereof, whether the processing capability is sufficient enough to bear the total traffic accessed to the local standard network is:
when the accessed traffic is greater than a processing capability threshold of the local standard network, when the local standard network is incapable of working, or when a user terminal exceeding the processing capability of the local standard network accesses the local standard network, determining that the local standard network is incapable of bearing the total traffic accessed to the local standard network.

16. The apparatus for disabling a standard network according to claim 13, wherein the disabling information further comprises a manner of disabling the local standard network, the manner is a disablement manner of lowering down power consumption step by step or a disablement manner of disabling directly and is determined by the network management system according to the number of user terminals in an idle state in the local standard network, so that the local standard network disables the local standard network in the disablement manner.
